(19) United States
(12) Patent Application Publication
(10) Pub. No.: US 2007/0012188 A1
(43) Pub. Date: Jan. 18, 2007

(54) Apparatus and method for removing contaminants from a gas stream

(76) Inventors: Hans P. Tandon, Pittsburgh, PA (US); Christine Illig Tandon, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/481,420

(22) Filed: Jul. 5, 2006

Related U.S. Application Data
(60) Provisional application No. 60/696,715, filed on Jul. 5, 2005.

(51) Int. Cl. B01D 46/00

(52) U.S. Cl. 95/273

(57) ABSTRACT

A pollution control system including a filtering unit for removing contaminants present in air streams or other gas streams including mercury, ultra-fine particulates, siloxanes, heavy metals, ultra-fine aerosols and mists (e.g., oil mists), condensed hydrocarbons, volatile organic compounds (VOCs), odors, radioactive emissions, gas-phase contaminants and microorganisms which includes a fixed filter section or belt style movable filter which can be automatically replaced with a new filter section.

### CROSS REFERENCE TO RELATED APPLICATIONS

This application claims the benefit of U.S. Provisional Application No. 60/696,715, entitled “Apparatus and Method for Removing Contaminants from a Gas Stream”, filed Jul. 5, 2005, and herein incorporated by reference in its entirety.

### BACKGROUND OF THE INVENTION

1. Field of the Invention

The present invention relates to methods of removing materials from a gas stream, more particularly to removing contaminants and/or recovering products from a gas stream via filtration and/or adsorption.

2. Description of Related Art

Contaminants present in air streams or other gas streams may include mercury, ultra-fine particulates, siloxanes, heavy metals, aerosols and mists (e.g., oil mists), condensed hydrocarbons, volatile organic compounds (VOCs), explosive dusts, odors, radioactive emissions, gas-phase contaminants, bacteria and viruses. Such contaminants can cause a range of problems, including undesirable air emissions to the atmosphere that exceed regulatory limits and can cause adverse health effects; air emissions that cause safety, housekeeping, or nuisance problems; undesirable contamination of indoor air environments; problematic contamination in waste gas, off-gas, or other gas streams to be used as fuels; contamination of process air streams causing problems in a production process. For these reasons, various industrial, commercial, and governmental entities have shown a need to remove these contaminants and/or a need for product recovery, the latter typically for economic reasons.

Conventional pollution control devices for removing contaminants from gas streams include activated carbon beds, baghouses, cartridge collectors, wet and dry scrubbing systems, spray-drying systems, oxidizers, and the like. These devices typically are large and often have high capital expense, may require significant process downtime due to a variety of issues, and can be expensive to operate and maintain. While roll-filter type filtration devices are more compact and often less costly, their use has been limited to filtration of particulate matter from gas streams. Conventional filtration systems including roll-filter type filtration devices such as disclosed in U.S. Pat. No. 4,662,899 do not remove mercury, siloxanes, gas-phase contaminants, ultra-fine particulate, bacteria or viruses. Further, conventional roll-filter type devices for particulate removal are not self-cleaning. A need remains for a device for removing these other contaminants that is compact, less costly overall, and requires no downtime for replacement of spent material. A second source of need is for a ‘polishing’ control step on applications where an existing device no longer meets the regulatory requirements (e.g., if regulatory limits have become more stringent over time). In this case, a compact, lower cost device is needed to provide additional contaminant removal.

### SUMMARY OF THE INVENTION

This need is met by the filtration system and method of the present invention of removing materials from gas streams. By gas stream it is meant air stream, exhaust gas from a process, in-process gas stream, or stream of other gas such as fuel gas or waste gas. The materials to be removed from gas streams in the present invention may be contaminants present in the gas stream or desirable materials to be recovered from the gas stream. The filtration system includes a housing defining a chamber across which a filter media belt or fixed filter media section or sections extend. A gas stream containing materials to be removed passes through the chamber and is cleaned as it passes through the filter media.

If a filter media belt is used (i.e., in lieu of fixed sections of media), the filter belt is supplied from a supply roll exterior to the chamber. The filter belt may be indexed across the chamber as needed to provide fresh filter media from the supply roll to the gas stream undergoing treatment. Used filter media is wound on a take-up roll exterior to the chamber. The filtration system may further include a mechanism that senses the need for fresh filter media, thereby indexing the filter media through the chamber for winding on the take-up roll. The spent filter roll can be replaced by a fresh filter roll without any system or process downtime, as the new filter can be fed through the chamber by attaching it to the old filter roll.

Materials that may be removed from gas streams by the system include mercury, ultra-fine particulates, siloxanes, heavy metals, ultra-fine aerosols and mists (e.g., oil mists), odors, radioactive emissions, acid gases and other soluble gaseous contaminants and microorganisms, such as bacteria and viruses. The filter media composition, the gas velocity across the filter (termed herein gas velocity), and the gas temperature are selected and controlled to obtain a desired control efficiency for the material to be removed from the gas stream.

The present invention further includes a method of removing these materials from gas streams including steps of providing a gas stream containing the materials for removal in the above-described system; selecting a filter media for filtering the gas, selecting a gas velocity, and selecting a gas temperature that together provide a desired control effect on the gas stream to remove the materials therefrom; and passing the gas stream through the selected filter media at the selected velocity to remove the materials from the gas stream.

In another embodiment of the invention, used filter media bearing material (especially, ultra-fine particulates) filtered from the gas stream that exits the chamber may be cleaned by vacuuming the filter media or pulsing the filter media with compressed gas to remove the materials collected on the filter, or both. By cleaning the filter media, replacement filter media costs are substantially reduced via recycling of the media, either manually or automatically. Also, the system may be operated for vastly extended time without the need for filter changeout and filtered material can be recovered.

### BRIEF DESCRIPTION OF THE DRAWINGS

FIG. 1 is a schematic front elevation view of one embodiment of the system used in the present invention;

FIG. 2 is side elevation view of the system shown in FIG. 1;

FIG. 3 is a schematic front elevation view of another embodiment of the invention including the system with vacuum;

FIG. 4 is a schematic top view of the system shown in FIG. 3;

FIG. 5 provides data on the particulate fractional control efficiency of one embodiment of the present invention; and

FIG. 6 is a graph of system performance in filter loading and cleaning cycles.

### DETAILED DESCRIPTION OF THE INVENTION

A complete understanding of the present invention will be obtained from the following description taken in connection with the accompanying drawing figures, wherein like reference characters identify the parts throughout.

For the purposes of the following description, the terms “above,” “below,” “top,” “bottom,” “vertical,” “horizontal,” and derivatives thereof refer to the invention as oriented in the drawing figures. However, it is to be understood that the invention may assume alternative variations and step sequences, except where expressly specified to the contrary. It is also to be understood that the specific devices and processes illustrated in the attached drawings and described in the following specification are exemplary embodiments of the invention. Specific physical characteristics related to the embodiments disclosed herein are not considered to be limiting.

The present invention includes a method of removing materials from a gas stream via filtering and/or adsorbing using a fixed filter system or a roll-filter filtration system as described herein and as disclosed in U.S. Pat. No. 4,662,899, incorporated herein by reference. References to filtration, filtering, filter media and the like herein should be understood to encompass other techniques and components for removal of materials, including adsorption. In a fixed filter system, sections of filter media are installed in a filter housing and periodically replaced. The present invention is described herein primarily with reference to roll-filter filtration systems, but this is not meant to be limiting. Fixed filter systems are also suitable for use.

The method includes steps of identifying the material (contaminant) within a gas stream to be removed and selecting filter media, gas velocity, and gas temperature appropriate therefor. Factors that are considered in the method include at least the type of contaminant to be removed (e.g., particulate size distribution, chemistry, corrosiveness), gas properties (e.g., temperature, moisture content, corrosiveness), and economic considerations.

The device and method of the present invention that includes a filtration device that is compact and cost-effective to install and operate. The present invention is suitable for use in removing mercury, ultra-fine particulates, siloxanes, heavy metals, ultra-fine aerosols and mists (e.g., oil mists), acid gases and other soluble gaseous contaminants, odorous materials, radioactive materials and microorganisms from gas streams. Ultra-fine particulates, aerosols, and mists include solid or liquid-phase particulate and aerosol having an aerodynamic particle diameter less than 0.55 micron, such as 0.001-0.5 micron. Gas-phase contaminants include acid gases (e.g., hydrogen chloride) and other gas-phase contaminants that are soluble in either water or another liquid scrubbing solution. Siloxanes include various combinations of silicon and organic compounds, with examples including but not being limited to the following: decamethyltetrasiloxane, decamethylcyclopentasiloxane, dodecamethylpentasiloxane, dodecamethylcyclohexasiloxane, hexamethyldisiloxane, hexamethylcyclotrisiloxane, octamethyltrisiloxane, and octamethylcyclotetrasiloxane. Odorous materials include organic and sulfurous compounds that emit an odor. Explosive dust includes dusts of explosive material, such as aluminum and certain other metals, paper and coal. Microorganisms that may be controlled via the method of the present invention include bacteria and viruses.

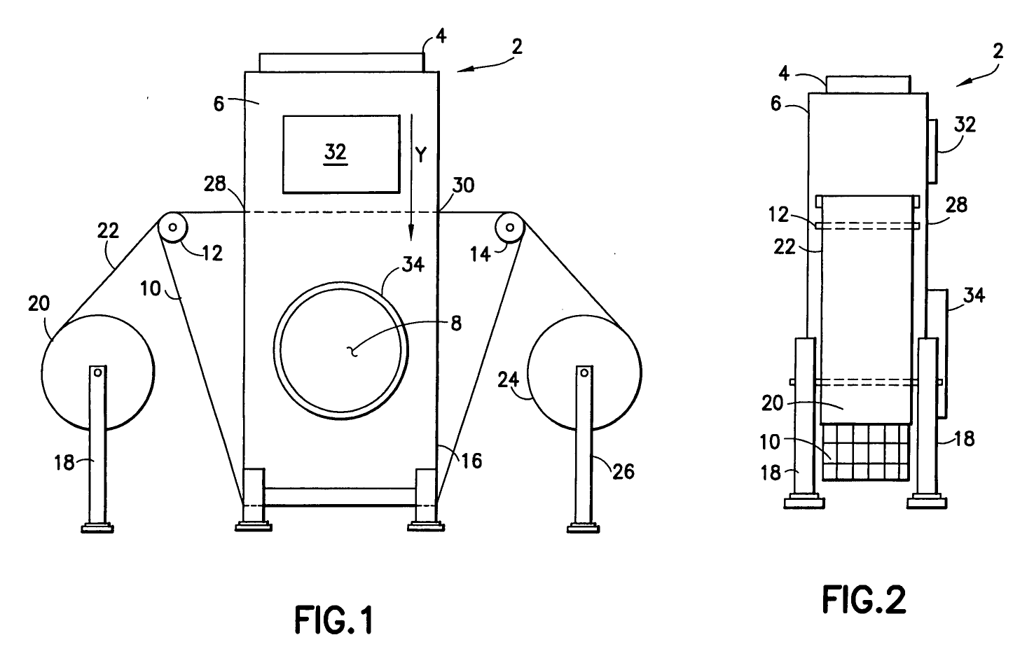

The present invention includes a filtration system 2, such as a fixed filter system or a roll-filter system, the latter as shown in FIGS. 1 and 2. As shown in the elevation view of FIG. 1, gas from which contaminants are to be removed is collected via ductwork (not shown) and passed via inlet port 4 into a housing 6 that defines a chamber 8 in the direction of arrow Y. A continuous wire mesh support belt 10 travels over sprockets 12 and 14 and similar support elements (not shown) at the base 16 of the housing 6. A pair of brackets 18 support a supply roll 20 of filter medium. A take-up roll 24 is supported by a pair of brackets 26 (only one is shown in FIGS. 1 and 2), thereby forming a filter belt 22 extending between supply roll 20 and take-up roll 24. A drive motor (not shown) drives the support belt 10 and filter belt 22 to advance the filter medium. The housing 6 defines a filter medium inlet 28 and outlet 30. Access door 32 defined in an upper portion of the housing 6 provides access to the chamber 8. Treated gas exits the housing via outlet port 34. The filter belt 22 spans the chamber 8 such that the gas flowing into inlet port 4 passes through the filter belt 22 and support belt 10 and exits the housing 6 via outlet port 34. Outlet port 34 is configured to be connected via ductwork with an exhaust stack or downstream gas processing components. The inlet port 4 and the outlet port 34 are shown at the top and side, respectively, of the housing 6, but this is not meant to be limiting. Other configurations are possible, with one or more inlet ports and outlet ports located on any side of the housing 6. Unit dimensions are based on the gas stream flow rate and the design velocity.

In one embodiment of the invention, the filter belt 22 is provided between the supply roll 20 and the take-up roll 24 in order to provide a continuing supply of filter media. Supply roll 20 of the filter medium 22 may be loaded and unloaded from the system 2 as needed. A gas stream containing contaminants enters the housing 6 and then passes through the filter belt 22 (and support belt 10), with contaminants collected on the filter belt 22. In this manner, the portion of the filter belt 22 exposed to the gas stream within the chamber 8 becomes loaded with the contaminants in the gas stream. After a certain period, a clean section of filter belt 22 is moved into the chamber 8, and the contaminant-loaded section of the filter belt 22 exits the chamber 8. Movement of the support belt 10 and filter belt 22 may be performed manually or automatically. These movement (‘indexing’) events can occur based on certain set points being reached on instrumentation (i.e., pressure differential across the filter belt 22 or concentration of contaminants present in the air downstream of the device reach a certain level). Automatic indexing of the filter belt 22 may be triggered by such instrument readings and a controller. The length of filter belt 22 entering the chamber 8 during each indexing event can vary, such as from one inch to several feet, and can likewise be based on certain instrument set points being reached.

Alternatively, a fixed filter section or sections can be used instead of a filter belt. In this embodiment, a fixed section of filter media is positioned across the gas stream within the chamber 8, typically with a support below it, such that the gas passes through the filter and the support as it passes from inlet to outlet until the filter is spent (i.e., loaded with contaminants), then requiring a manual replacement. This embodiment is similar to the filter belt embodiment described above except that the filter section is sized to fit within the chamber 8 and is not attached to any filter roll. One or more sections of media can be used to span the chamber, and multiple sections may be in place in series for the gas stream to be cleaned to required levels.

The present invention includes methods of removing contaminants from gas streams using the system 2. The selection of gas velocity, gas temperature, system configuration, material of filter medium and/or control of the system 2 provide a method of operating the system 2 in a manner to remove contaminants that heretofore has not been accomplished.

Single or multiple stage filter units may be utilized to achieve the target control efficiency. The system 2 may further include a blower and motor to move the gas through the system 2. The side elevation view of FIG. 2 shows the contaminated gas inlet port 4, the filter belt 22, and locations of the supply 20 and take-up 24 rolls.

The invention described herein uses a media with fiber sizes between 0.1 and 200 micron and have a total thickness of less than 1.0 inch, except for the activated carbon media, which can be applied up to and beyond a few feet thick. In one embodiment, a filter belt 22 having a heat-treated or singed filter surface is suited for contaminant collection.

In general, the filter material is selected based on the type of materials to be removed, the characteristics of the gas stream, and also may be based on gas temperature. In general, activated carbon media are effective up to about 450° F., electrically charged media and polypropylene media are effective up to about 200° F., polyester media are effective to about 300° F., and fiberglass media may be used for temperatures reaching approximately 550° F.

The velocity of gas across the filter belt 22 may be controlled to achieve the desired filtration performance and is selected based on contaminant characteristics and on the filter media. More particularly, the gas velocity may range from 1 to 2,500 feet per minute (fpm) or 1 to 1800 fpm, as further indicated below.

For mercury removal, the filter medium may include in its composition activated carbon, the media being manufactured either by a process of coating and binding the activated carbon, or another mercury adsorbent, onto a substrate or by another process resulting in a filter that includes in its composition activated carbon (or other mercury adsorbent) that is fixed in place in the filter media. The activated carbon-containing filter media is manufactured either by a process of coating and binding the activated carbon onto a substrate or by another process resulting in a filter that includes in its composition activated carbon that is fixed in place in the filter media. Alternatively, activated carbon may be produced in a sheet form without a filter substrate. The activated carbon can be impregnated with other chemicals (e.g., sulfur, bromine, halogens) to further enhance mercury control, or the mercury adsorbent may be a different adsorbent material than activated carbon or impregnated activated carbon. The filter medium may be approximately 0.02 inch to three feet thick. The gas velocity is about 1-2500 fpm, with higher performance in the 10-200 fpm range. Control efficiency generally improves with decreasing temperature. Gas stream temperature can be lowered by a variety of means, including but not limited to use of a heat exchanger, gas quenching with a liquid, and dilution with cooler air. As with the method generally, the gas may pass through a single stage of filter or through multiple filter stages to remove contaminants to the desired level.

Removal of ultra-fine particulates (sized less than 0.55 micron, such as 0.001-0.5 micron) may be performed using various filter media that are selected depending on particulate size, air temperature, and required control efficiency. These media contain fibers (such as polyester fibers) sized between 0.1 and 200 micron and have a total thickness of less than 1.0 inch. Gas velocities may range from 10 to 2,500 fpm or 250-2,500 fpm or 250-1000 fpm for these applications, depending on filtration medium used. For some ultra-fine particulate resisting collection by other media, a fibrous filter media that possesses an electrical charge is used and the gas velocity is 1-1000 fpm or 1-500 fpm. This media may consist of a single positively or negatively charged sheet, or may consist of both positively and negatively-charged sheets separated by a membrane. Ultra-fine particulates, aerosols and mists (oil mists), and condensed hydrocarbons and volatile organic compounds (VOCs) are collected and retained by the filter by mechanisms that include the electrostatic forces inherent to the filter media. When using filter media that do not possess an electrical charge, gas velocities of 250 to 2500 are used.

For siloxane control, suitable filter media include such filter media that possesses an electrical charge as described above or a two-stage approach, which uses electrically-charged media, as the first stage and activated-carbon-containing filter material (as described above) at 1-1,000 fpm, as the second stage. Typically siloxane control may use a fixed filter section or sections in place of the movable belt 22. Also, either of the two media stages (electrically-charged and activated carbon) may have more than one stage for the gas to pass through for enhanced efficiency.

For removal of acid gases and other gas-phase contaminants, filter media that function under wet conditions may be used such as polypropylene or polyester, typically of thickness less than one inch. In operating the system 2 to remove gas-phase contaminants, the gas-phase contaminants are absorbed, dissolved, adsorbed or otherwise captured into or onto fine liquid droplets by introducing a fine mist of water or other scrubbing liquid via a spray nozzle (not shown) directly into the gas stream prior to entering the chamber 8. The sprayed liquid may react with the gaseous contaminants in the air stream prior to entering the chamber 8. The liquid droplets are subsequently caught by the filter media itself, creating a wet filter through which the gas stream passes. As any remaining unreacted gaseous contaminants are forced through the very fine pores of the filter media, they are absorbed, impacted, adsorbed, and otherwise collected into the scrubbing liquid that is coating the media. The liquid droplets, which have trapped the gaseous contaminants, then fall to the bottom of the invention and exit through a drain (not shown). The clean gas passes out through outlet port 34.

For control of explosive dusts, a suitable filter medium is a fibrous filter medium that may be less than one inch thick. In use, a gas stream containing explosive dust is combined with a fine mist of water. The resulting moist explosive material is collected on the filter medium and kept wet or damp to prevent explosion.

Bacteria and viruses are controlled by filtration with the electrically charged filter medium described previously, at velocities of 1-1000 fpm.

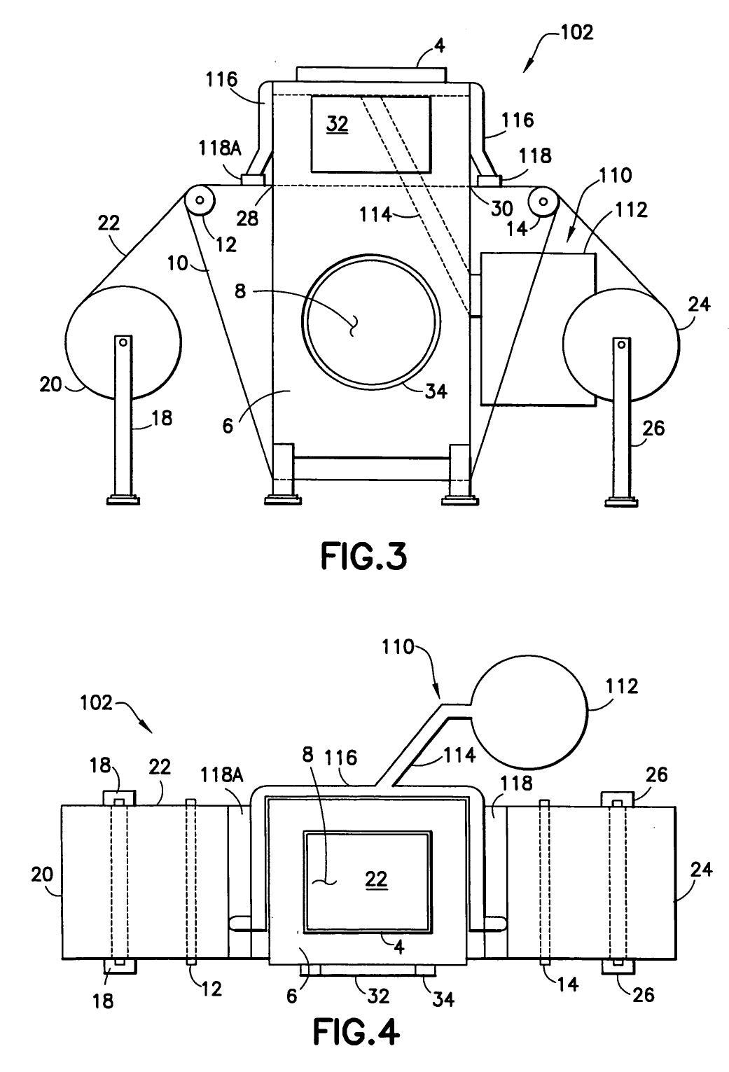

FIGS. 3 and 4 show another embodiment of the invention that is particularly suited at least for removing fine particulates. The system 102 includes many of the components of the system 2 and further includes a self-cleaning system 110 to extend filter belt life. In one embodiment, the self-cleaning system 110 includes a vacuum device 112 connected via tubing 114 and manifold 116 to elongated nozzle 118 and optional elongated nozzle 118A. Elongated nozzle 118 is positioned adjacent an upper surface of filter belt 22 for removing the filter residue formed on the filter bed 22 as the filter bed 22 exits the housing 6 and is wound up on take-up roll 24. Nozzles 118 (and 118A) is sized to fit across the width of the filter belt 22. For the system 102 having automatic indexing of the filter belt 22, the filter belt 22 slowly passes by vacuum nozzle 118. The nozzle 118 may be fitted with a brush or brushes to enhance particle separation and collection from the filter belt 22. Alternatively, the filter belt 22 may be cleaned using a pulsed gas system (not shown) via pulsing a compressed gas (e.g., air) through the clean side (under side) of the filter belt 22 and collecting the contaminants in a hopper (not shown). Standard plant compressed air can be used at 40-150 psi through nozzles that periodically pulse air through the dirty filter belt 22 as it passes the nozzles. The nozzles, for either the compressed air or the vacuum, can be mobile or fixed in place. In cases where material or product recovery is desired, the material that has been vacuumed or pulsed from the filter is available for recovery from the vacuum tank or hopper for collecting the pulsed material, or other collection area. The clean gas passes out outlet port 12. In this embodiment, the cleaned roll may be manually returned from the take-up brackets 26 to the supply brackets 18 to be re-fed back through the housing 6. Different filter media provide differing levels of performance with respect to cleaning, with certain media types including singed filter media, less than 1 inch thick, providing enhanced particulate release properties. In addition, the control efficiency of the system 102 on fine particulate increases as time passes with the reversing filter belt 22, as the collected filter residue (i.e. filter cake) provides an additional filtering mechanism.

In yet another embodiment, the filter may be cleaned and then automatically reverse directions. After the full roll of the filter belt 22 passes through the housing 6 and is subsequently cleaned by nozzle 118, and rolled up on take-up roll 24, the filter belt 22 may be automatically sent back through the housing 6 in the opposite direction. A signal to reverse direction or to replace the cleaned roll back to the supply brackets 18 may be triggered by a level control, electric eye, or other device that senses when the supply roll 20 is low. (Alternately, under a similar approach the filter can reverse direction any number of times for a given section of filter before moving to the next section of filter.) In the automatic reversal embodiment, when the filter reverses direction, the vacuum nozzle 118A may be employed (automatically or manually) on the other side of the housing 6 such that the dirty filter belt is cleaned upon exiting the housing 6. Automatic changeover of the suction location may be achieved with a flow valve or valves (not shown) that receive an electronic signal and direct the vacuum flow through the manifold 116 to one side of the housing 6 or the other. This process of going forward and reverse is repeated until the filter belt 22 is spent, which may be determined by when the filter belt 22 can no longer reach a low set point pressure differential or by when the filter belt 22 indexes excessively. Filter changeout requires no downtime for the unit or the production process as the filter rolls are located outside the housing 6 and the new filter can be fed through by attaching it to the old filter.

It has been found that the present invention removes the mercury without the problems of carbon bed plugging and associated high activated carbon replacement costs, and very high carbon-to-mercury loading requirements (i.e., high carbon costs and large solid waste disposal issues) with dry injection/dry scrubbing systems. For ultra-fine particulate control, the present invention provides higher control efficiency relative to a baghouse or cartridge collector, but with a much smaller size and weight than these devices. Compared to an activated carbon or other adsorbent bed for siloxanes control, the present invention provides good removal efficiency (e.g., 90%+ control) without the aforementioned problems of carbon-bed plugging high replacement costs of activated carbon or other adsorbent. Use of activated carbon for siloxanes control has the further disadvantage as it can also adsorb desirable constituents from the gas stream (e.g., remove high heat value constituents from off-gases to be used as a fuel source). For acid gases and other gas-phase contaminants, the present invention provides comparable removal efficiency to a wet scrubber but with a much smaller size and weight (e.g., under 50%).

The following examples are merely illustrative of the invention, and are not intended to be limiting.

### EXAMPLES

### Example 1

### Mercury Control

Wastewater treatment gas exhaust from a sludge incinerator was treated according to the present invention. Fine particulate and mercury were removed with a fine particulate filter media (as described above) followed by a section of activated carbon filter media. Mercury was removed at approximately 50% efficiency in a single pass across the filter in both tests, which used the equivalent of ⅜ ″ thick activated carbon-containing media described previously, as shown in Table 2. EPA Test Method 29, modified, was used for mercury determination. Multiple units in series, multiple passes through the same media and/or use of impregnated activated carbon, can be used to increase the removal efficiency from 50% to 95%+.

TABLE 2
Efficiency of Mercury Removal

| | Run 1 | Run 2 |
|---|---|---|
| Filter media—Stage 1 | A8-A | A8-A |
| Filter media—Stage 2 | AC-M (3/16″× 2) | AC-J (3/8″) |
| Control Efficiency (%) | 55.3% | 47.3% |

### Example 2

### Ultra-Fine Particulate Control, Full Scale

Smoke from a waste incinerator having a particle size distribution as shown in Table 3 was treated according to the present invention by a full-scale version of the invention. Table 3 shows data on the particle size distribution of smoke filtered as in this example. The system demonstrated an average of 94% removal of the fine smoke particulate, including removing a majority of the ultra-fine particulate (i.e., under 0.55 micron size), over three one-hour tests.

TABLE 3
Particle Size Distribution for Full-Scale Particulate Test

| Flow | | | | | | | Particle |
|---|---|---|---|---|---|---|---|
| Rate | | Tare Wt | Final Wt | Net Wt | % in | Cumulative | Size |
| (ACFM) | Stage | (g) | (g) | (mg) | Size Range | < Size Range | (microns) |
| 0.56 | 0 | 0.14973 | 0.15143 | 1.70 | 1.73 | 98.3 | 4.0 |
| 0.56 | 1 | 0.14345 | 0.14568 | 2.23 | 2.26 | 96.0 | 9.0 |
| 0.56 | 2 | 0.15141 | 0.15318 | 1.77 | 1.80 | 94.2 | 6.0 |
| 0.56 | 3 | 0.14306 | 0.14464 | 1.58 | 1.60 | 92.6 | 4.1 |
| 0.56 | 4 | 0.15018 | 0.15244 | 2.26 | 2.29 | 90.3 | 2.6 |
| 0.56 | 5 | 0.14053 | 0.16141 | 20.88 | 21.20 | 69.1 | 1.3 |
| 0.56 | 6 | 0.1511 | 0.17576 | 24.66 | 25.04 | 44.1 | 0.82 |
| 0.56 | 7 | 0.13996 | 0.15555 | 15.59 | 15.83 | 28.2 | 0.55 |
| 0.56 | Backup | 0.16527 | 0.19308 | 27.81 | 28.24 | — | <0.55 |
| | Filter | | | | | | |
| | | | | 98.48 | | | |

### Example 3

### Ultra-Fine Particulate Control, Pilot Scale

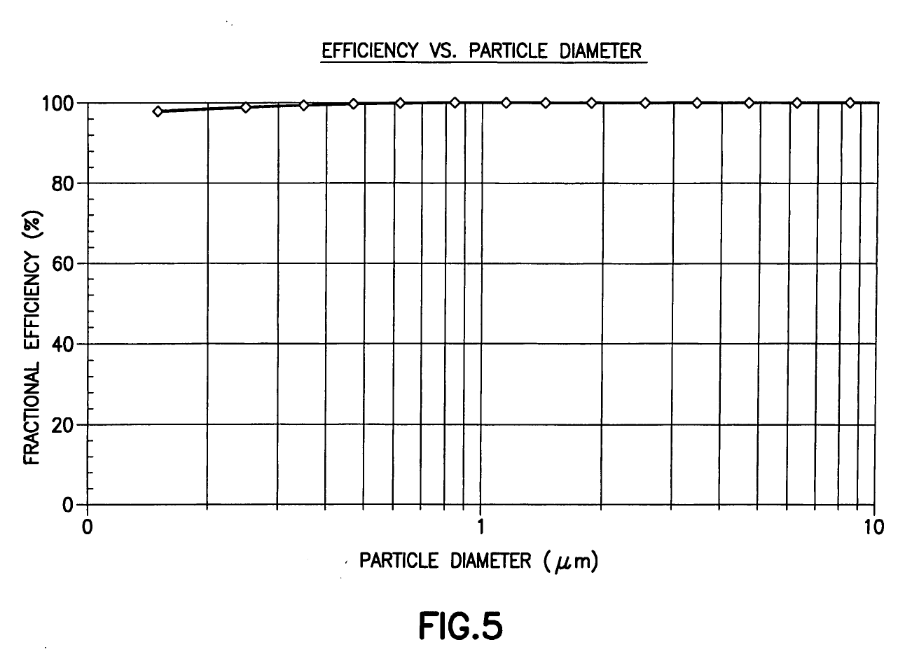

A standardized particle sample having a known particle size distribution from 0.1-10 microns was treated in a pilot scale version of the present invention in air at 100 fpm using an electrically charged synthetic fiber filter. The ability of the electrically charged filter media at this gas velocity to remove fine particles is shown in FIG. 5 where the filtration efficiency was over 98% for the ultra-fine particle sizes in the sample.

### Example 4

### Filter Media Cleaning

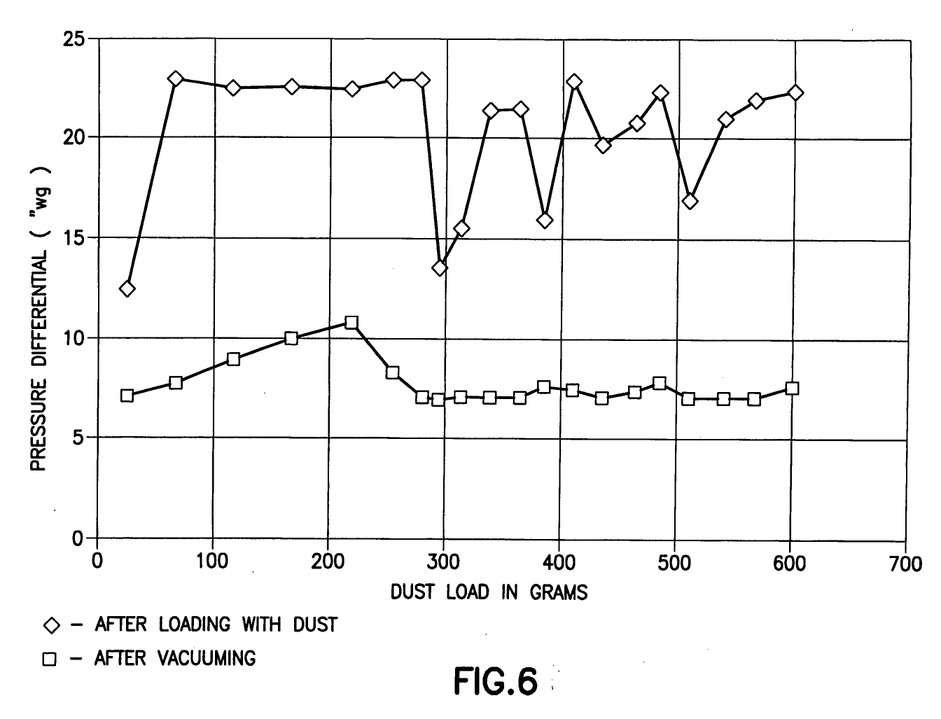

Smoke from a waste incinerator was treated according the present invention. The pressure drop across the filter was measured with the filter loaded with dust collected from the smoke. The loaded filter was vacuumed to remove the dust and the pressure drop was remeasured. As shown in FIG. 6, the system continued to perform following repeated loading, filtration, and cleaning cycles with the pressure drop across the filter returning to essentially the same point after many cleaning passes.

While the present invention has been described with reference to a particular embodiment of a pollution control system and a method associated herewith, those skilled in the art may make modifications and alterations to the present invention without departing from the spirit and scope of the invention. Accordingly, the forgoing detailed description is intended to be illustrative rather than restrictive. The invention is defined by the appended claim, and all changes to the invention that fall within the meaning and range of equivalency of the claim are embraced within their scope.

The invention claimed is:

1. In a method of filtering gas streams using a filtering unit comprising a housing having an inlet and a outlet, a filter extending across said housing whereby gas streams flow through said filter, wherein said improvement comprises:
providing gas streams containing a contaminant selected from the group consisting of mercury, siloxanes, ultra-fine particulates, ultra-fine aerosols and mists, gas-phase contaminants, heavy metals, odorous materials, radioactive materials, explosive dust and microorganisms;
identifying filtration media for said filtering unit suitable for removing said contaminant from said gas stream;
selecting a gas velocity and gas temperature that provides a desired control effect on the gas stream to remove the contaminant therefrom; and
passing the gas stream through the selected filter media at the selected velocity and temperature to remove the contaminant from the gas stream.

2. The method of claim 1 wherein said contaminant comprises mercury and said identified filtration media comprises activated carbon.

3. The method of claim 2 wherein said activated carbon is fixed to a filter substrate.

4. The method of claim 3 wherein said activated carbon is impregnated with additional components for enhancing mercury adsorption.

5. The method of claim 2 wherein said selected gas velocity is 1-2000 feet per minute.

6. The method of claim 5 wherein said selected gas velocity is 10-200 feet per minute.

7. The method of claim 2 wherein said filtration medium is 0.2 inch to three feet thick.

8. The method of claim 2 wherein said gas temperature is up to 450° F.

9. The method of claim 1 wherein said contaminant comprises siloxanes and said identified filtration media comprises electrically charged media or activated carbon.

10. The method of claim 9 wherein said selected gas velocity is 1-1000 feet per minute.

11. The method of claim 1 wherein said contaminant comprises ultra-fine particulates wherein said identified filtration media comprises fibrous media and said selected gas velocity is 10-2500 feet per minute.

12. The method of claim 1 wherein said contaminant comprises ultra-fine particulates wherein said identified filtration media is electrically charged and said selected gas velocity is 250-2500 fpm.

13. The method of claim 1 wherein said gas-phase contaminant comprises an acid gas or other gaseous contaminant that can be removed effectively by a wet scrubber and said identified filtration media comprises media configured to filter said acid gas captured in liquid form, wherein said gas phase contaminant is captured into or onto fine liquid droplets through the introduction of a fine mist of water or other scrubbing liquid upstream of the filter.

14. The method of claim 1 wherein said filter comprises a movable filter support bed extending across said housing and supporting said filter, said support bed and filter exiting said housing when said filter is loaded with contaminants.

15. The method of claim 14 wherein said filtering unit further comprises a self-cleaning system for removing contaminant filtrate from said loaded filter upon exiting said housing.

16. In a filtering unit comprising a substantially vertical housing having an upper inlet and a lower outlet, a horizontal movable filter belt extending across said housing whereby a gas stream containing contaminants flows downward through said filter to remove the contaminants from the gas stream, the improvement comprising a self-cleaning system for removing contaminant filtrate from a portion of said filter extending out of said housing.

17. The filtering unit of claim 16 wherein said self-cleaning system comprises a vacuum nozzle or compressed air nozzle positioned adjacent to the dirty side of said filter belt, said vacuum nozzle being in communication with a vacuum source or compressed air nozzle in communication with an air supply.

18. The filtering unit of claim 16 wherein said filter bed comprises a filter media adapted to remove contaminants from a gas stream, said contaminants selected from the group consisting of fine particulates, heavy metals, radioactive components and microorganisms.

19. The filtering unit of claim 18 wherein said filter belt is comprised of a material of less than one inch thick.

20. The filtering unit of claim 16 further comprising a second vacuum nozzle, wherein each nozzle is positioned on an opposing side of said housing, whereby contaminated filtrate is removed from said filter by one nozzle when said filter moves in a first direction and is removed from said filter by the other nozzle when said filter moves in a reverse direction.
